(19) United States
(12) Patent Application Publication
(10) Pub. No.: US 2007/0195513 A1
(43) Pub. Date: Aug. 23, 2007

(54) ILLUMINATION-TYPE ROTATIONAL CONTROL DEVICE

(75) Inventors: Yoshinoari NISHIYAMA, Miyagi-ken (JP); Ayumu Kobayashi, Miyagi-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/676,091

(22) Filed: Feb. 16, 2007

(30) Foreign Application Priority Data
Feb. 17, 2006 (JP) 2006-041079

(51) Int. Cl. G01D 11/28

(52) U.S. Cl. 362/23

(57) ABSTRACT

A rotatable control knob for actuating a rotary switch includes a slit serving as a pointer display element. An illuminating portion of a light guiding unit attached to the control knob is disposed in the slit. A strip light-guiding portion extends spirally from the illuminating portion is secured to the inner surface of the control knob. Thus, light emerging from a planar light-emitting unit disposed under the control knob is incident on the lower surface of the strip light-guiding portion and is guided through the strip light-guiding portion to the illuminating portion. This allows the illuminating portion illuminated with high intensity in the slit so as to function as an indicator.

This application claims the benefit of priority under 35 U.S.C. §119 to Japanese Patent Application No. 2006-041079, filed Feb. 17, 2006, which is hereby incorporated by reference in its entirety.

### BACKGROUND OF THE INVENTION

1. Field of the Invention

The present invention relates to illumination-type rotational control devices mounted on vehicle instrument panels and the like, which are used as a variety of input means, and particularly relates to an illuminating mechanism for an indicator provided in a rotatable control knob.

2. Description of the Related Art

For a rotational control device included in in-vehicle air conditioning systems, audio systems, and the like, it is necessary that a rotational position of a control knob to be manually operated by an operator (i.e., driver or passenger) is visible, even in a poorly lit environment. Therefore, an illuminating mechanism for illuminating a pointer display element of a control knob with light from the back of the control knob is widely used. The pointer display element is provided for an indicator and located at a predetermined position about the control knob.

There is a known illumination-type rotational control device having an illuminating mechanism as described above and in which a pointer display element is provided at a predetermined position in a control knob, which is rotatably supported inside a panel. This illumination-type rotational control device is configured such that light emerging from a light guiding unit disposed inside the panel is applied to the backside of the control knob, and thus the pointer display element moving in synchronization with the rotation of the control knob is illuminated (see, e.g., Japanese Unexamined Patent Application Publication No. 2002-231101). The control knob is made of light shielding material, such as acrylonitrile butadiene styrene (ABS) resin. The pointer display element is made of optically transparent material, which fills a hole or channel provided in the control knob. The light guiding unit is formed in the shape of a mortar with an upper end face serving as an outgoing surface that is annular in shape. Light emitted from a light source, such as a lamp, is incident on the lower end of the light guiding unit and emerges from the upper end face of the light guiding unit. Thus, the backside of the control knob including the pointer display element is annularly irradiated with the light emerging from the light guiding unit.

Since the known illumination-type rotational control device described above is configured such that the backside of the rotatable control knob is irradiated with light emerging from the light guiding unit, the pointer display element illuminated with this light is visible from outside the control knob and is uniform in brightness regardless of the rotational angle of the control knob. However, for the pointer display element, which moves in synchronization with the rotation of the control knob, to be consistently illuminated at the same level of intensity, it is necessary that light emerging from the light guiding unit be annularly applied to the backside of the control knob including the pointer display element. This increases the amount of light wasted because it is blocked by the backside of the control knob and cannot be used as light for illuminating the indicator. Also, this causes problems of insufficient brightness of the indicator and an increase in the amount of electric power consumed by the light source.

### SUMMARY OF THE INVENTION

An object of the present invention is to provide an illumination-type rotational control device capable of illuminating a pointer display element for an indicator at high intensity, by effectively using light emerging from a planar light-emitting unit.

To achieve the object described above, an illumination-type rotational control device of the present invention includes a rotatable control knob composed of a tubular member having a top plate and includes a pointer display element, a light guiding unit integral with the control knob, and a planar light-emitting unit for allowing light to be incident on the light guiding unit. The light guiding unit has an illuminating portion disposed in the pointer display element and a strip light-guiding portion annularly extending along an inner surface of the control knob. The light guiding unit is configured to allow light emerging from the planar light-emitting unit to be incident on a lower surface of the strip light-guiding portion, and to guide the light to the illuminating portion.

In the illumination-type rotational control device configured as described above, the light guiding unit is integral with the rotatable control knob has the illuminating portion disposed in the pointer display element, where the strip light-guiding portion annularly extends along the inner surface of the control knob. Therefore, most of light emerging from the planar light-emitting unit and incident on the lower surface of the strip light-guiding portion can be guided to the illuminating portion without being wasted. Thus, it is made possible to illuminate the pointer display element for an indicator at high intensity, by effectively using light emerging from the planar light-emitting unit.

In the above-described configuration of the light guiding unit, the length in the direction parallel to the rotational axis of the control knob may be constant, from the illuminating portion at one end to the other end. However, it is preferable that the length in the direction parallel to the rotational axis of the control knob decreases with distance from the illuminating portion. In other words, it is preferable that the shape of the strip light-guiding portion be triangular with the illuminating portion as the base. With the strip light-guiding portion having such a configuration, light emerging from the planar light-emitting unit and incident on the lower surface of the strip light-guiding portion can be more easily reflected off the upper surface as feedback light. Therefore, light emerging from the planar light-emitting unit can be effectively guided through the strip light-guiding portion to the illuminating portion. It will be sufficient if either of the upper and lower surfaces of the strip light-guiding portion includes an inclined surface. However, light from the planar light-emitting unit can be more effectively guided to the illuminating portion if both the upper and lower surfaces of the strip light-guiding portion are inclined wit respect to respective planes orthogonal to the rotational axis of the control knob.

In the configuration described above, it will be sufficient if the planar light-emitting unit has a planar light exiting surface, which allows light to be incident on the lower surface of the strip light-guiding portion. However, it is further preferable if the planar light-emitting unit has an annular light exiting surface which allows light emitted from a light source to emerge obliquely toward the lower surface of the strip light-guiding portion, because the light emerging from the planar light-emitting unit can be incident on the light receiving surface of the strip light-guiding portion without being wasted.

In the illumination-type rotational control device of the present invention, the light guiding unit is integral with the rotatable control knob and has the illuminating portion disposed in the pointer display element with the strip light-guiding portion annularly extending along the inner surface of the control knob. The illumination-type rotational control device is configured such that light emerging from the planar light-emitting unit is incident on the lower surface of the strip light-guiding portion and is guided to the illuminating portion. Therefore, most of light emerging from the planar light-emitting unit and incident on the lower surface of the strip light-guiding portion can be guided to the illuminating portion without being wasted. Thus, it is made possible to illuminate the pointer display element for an indicator at high intensity, by effectively using light emerging from the planar light-emitting unit.

### BRIEF DESCRIPTION OF THE DRAWINGS

FIG. 1 is a cross-sectional view of an illumination-type rotational control device according to an embodiment of the present invention.

FIG. 2 is an exploded perspective view of main parts of the illumination-type rotational control device.

FIG. 3 is a perspective view of a light guiding unit in the illumination-type rotational control device.

FIG. 4 is a plan view of the light guiding unit.

FIG. 5 illustrates paths of light emerging from a planar light-emitting unit and incident on the light guiding unit.

### DESCRIPTION OF THE PREFERRED EMBODIMENTS

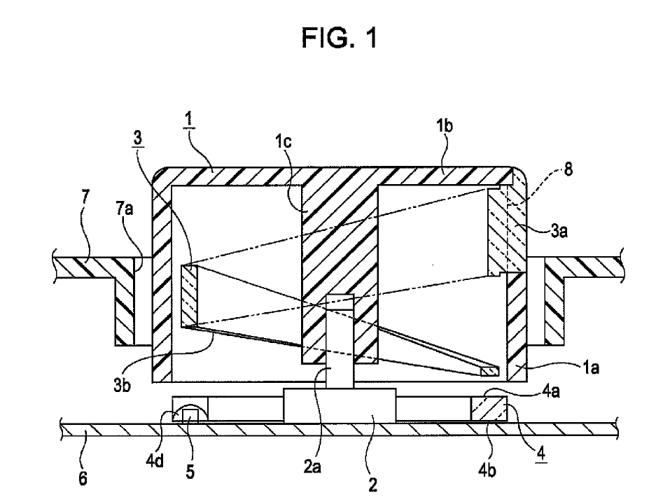

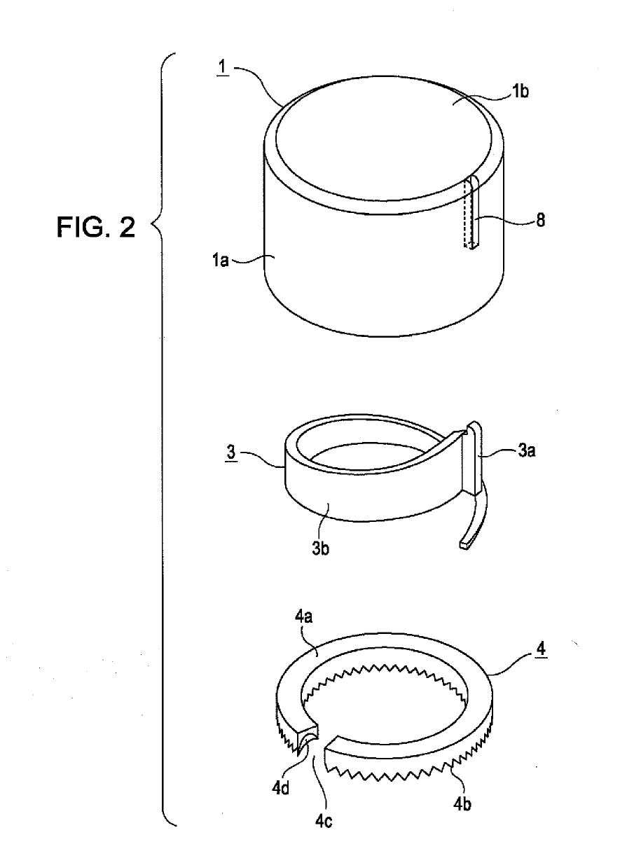

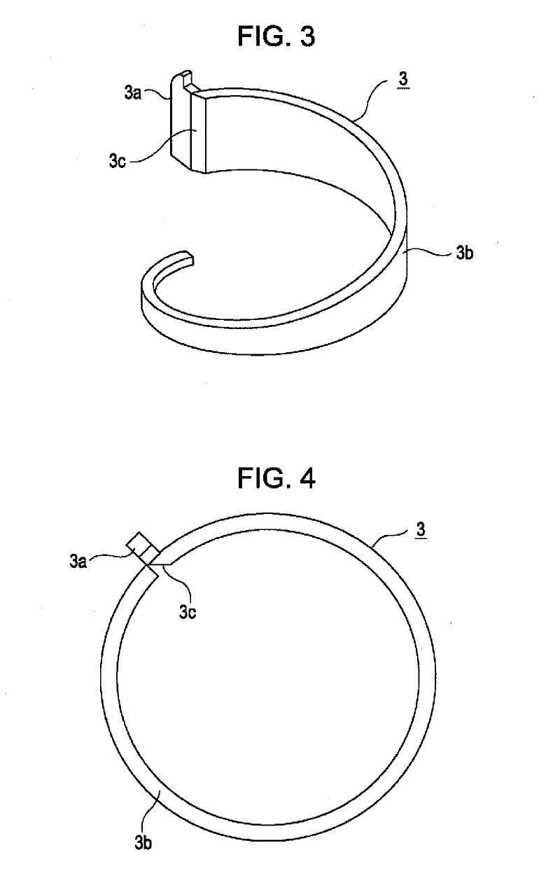

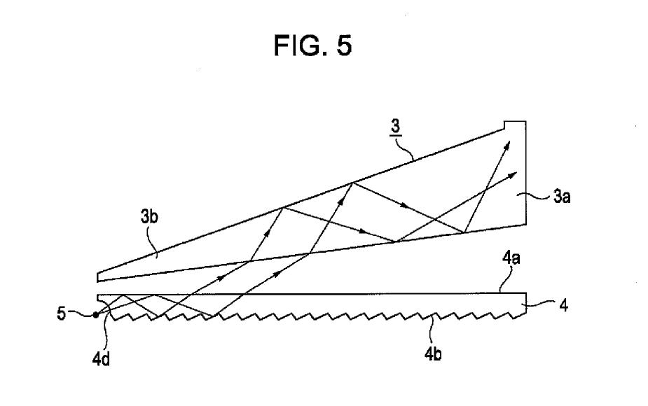

Embodiments of the present invention will now be described in detail with reference to the drawings. FIG. 1 is a cross-sectional view of an illumination-type rotational control device according to an embodiment of the present invention. FIG. 2 is an exploded perspective view of main parts of the illumination-type rotational control device. FIG. 3 is a perspective view of a light guiding unit in the illumination-type rotational control device, and illustrates the light guiding unit in an orientation different from that in FIG. 2. FIG. 4 is a plan view of the light guiding unit. FIG. 5 illustrates paths of light emerging from a planar light-emitting unit and incident on the light guiding unit.

An illumination-type rotational control device of the present invention is mounted on a vehicle instrument panel, center console box, and the like, and is used, for example, as an input means for setting a temperature of an air conditioning system. As illustrated in FIG. 1, the illumination-type rotational control device of the present invention includes a control knob 1 to be rotated by an operator (i.e., driver or passenger), a rotary switch 2 actuated by the rotation of the control knob 1, a light guiding unit 3 attached to the control knob 1 and rotating therewith, a planar light-emitting unit 4 disposed opposite the backside of the control knob 1, a light-emitting diode (LED) 5 serving as a light source for the planar light-emitting unit 4, and a printed circuit board 6 on which the rotary switch 2 and the LED 5 are mounted. The upper portion of the control knob 1 protrudes from an opening 7a provided in a panel member 7. Although not illustrated, the panel member 7 is provided with a display area corresponding to temperature scales (15° C., 20° C., 25° C., 30° C., and etc.) and the like. This display area is annular in shape and is provided around the opening 7a.

The control knob 1 is made of light-shielding synthetic resin, such as ABS resin. As for the exterior, the control knob 1 has a cylindrical side wall 1a and a top plate 1b disposed on top of the side wall 1a. A boss 1c is vertically disposed downward from the center of the rear surface of the top plate 1b. The lower end of the boss 1c engages a rotating shaft 2a of the rotary switch 2. As illustrated in FIG. 2, the control knob 1 is provided with a slit 8 extending downward from the top plate 1b to the middle of the side wall 1a. The relative position of the slit 8 with respect to the above-described display area of the panel member 7 changes as the control knob 1 rotates. The slit 8 thus serves to hold a pointer display element for an indicator indicating the rotational position of the control knob 1.

The light guiding unit 3 is made of highly optically transparent and colorless (or colored) synthetic resin, such as acrylic resin or polycarbonate resin. The light guiding unit 3 has a vertically extending bar-like illuminating portion 3a, and a strip light-guiding portion 3b extending spirally from the illuminating portion 3a. The light guiding unit 3 is attached to the control knob 1 with an adhesive or the like. This allows the illuminating portion 3a to be engaged with the slit 8 and exposed outwardly in such a manner that light can emerge outwardly from the illuminating portion 3a and, at the same time, allows the strip light-guiding portion 3b to be secured to the inner surface of the control knob 1. As illustrated in FIG. 2 through FIG. 4, the strip light-guiding portion 3b is uniform in thickness over the entire length. However, the strip light-guiding portion 3b is tapers in a manner such that a height (i.e., a length parallel to the rotational axis of the control knob 1) decreases with distance from the illuminating portion 3a. In other words, as illustrated in FIG. 5, the shape of the strip light-guiding portion 3b is triangular, with the illuminating portion 3a as the base. The upper and lower surfaces of the strip light-guiding portion 3b correspond to the two respective oblique sides of this triangle. As illustrated in FIG. 3 and FIG. 4, a reflecting surface 3c is provided at a joint portion between the illuminating portion 3a and the strip light-guiding portion 3b. The reflecting surface 3c is inclined about 45 degrees to a line tangent to the strip light-guiding portion 3b.

The planar light-emitting unit 4 is an annular molded product of highly optically transparent synthetic resin, such as acrylic resin or polycarbonate resin. The planar light-emitting unit 4 is mounted on the printed circuit board 6 to surround the rotary switch 2.

The planar light-emitting unit 4 has a light exiting surface 4a at the top from which light exits toward the strip light-guiding portion 3b, and includes a corrugated reflecting portion 4b at the bottom. The LED 5 is disposed in a slot 4c formed in the planar light-emitting unit 4. An end face of the slot 4c is provided with a light entering portion 4d having an arch-like cross-section. Thus, when light emitted from the LED 5 is incident on the planar light-emitting unit 4 through the light entering portion 4d, the light is reflected at the reflecting portion 4b and emerges as oblique illumination light from the light exiting surface 4a (see FIG. 5).

In the illumination-type rotational control device described above, when the operator turns the control knob 1 protruding from the opening 7a of the panel member 7, the rotating shaft 2a of the rotary switch 2 rotates in synchronization with the rotation of the control knob 1. This allows the rotary switch 2 to output to a control circuit (not illustrated), a signal corresponding to the amount of rotation of the control knob 1. Thus, the temperature of air from an air outlet can be controlled on the basis of this output signal. As the control knob 1 rotates, the slit 8 revolves inside the display area provided around the opening 7a. The illuminating portion 3a exposed to the outside from the slit 8 is visible even where illumination is not required nor used. Thus, a set temperature can be visibly recognized according to a position indicated on the display area of the panel member 7 by the slit 8 serving as a pointer display element.

When the LED 5 is turned on at night or in a dark place, such as in a tunnel, light from the LED 5 exits the light exiting surface 4a, enters the strip light-guiding portion 3b, and is guided to the illuminating portion 3a of the light guiding unit 3. The slit 8 can thus be illuminated with the light. The lower surface of the strip light-guiding portion 3b of the light guiding unit 3 secured to the inner surface of the control knob 1 is located immediately above the light exiting surface 4a of the planar light-emitting unit 4 formed in an annular shape. Therefore, as indicated by arrows in FIG. 5, light emerging obliquely upward from the light exiting surface 4a is incident on the lower surface of the strip light-guiding portion 3b, is reflected between the upper and lower surfaces of the strip light-guiding portion 3b, and is then reflected off the reflecting surface 3c and guided to the illuminating portion 3a. Thus, most of the light from the planar light-emitting unit 4 can be effectively used to illuminate the illuminating portion 3a. While the LED 5, which consumes less power than a lamp, is used as a light source, the illuminating portion 3a for the indicator can be illuminated with high intensity light.

Although in the foregoing embodiment the rotary switch 2 has been described as an example of a rotational-type electric component actuated by the rotation of the control knob 1, another type of rotational-type electric component, such as a rotary encoder or the like, may be used in place of the rotary switch 2.

Also, the overall configuration of the light guiding unit 3 including the illuminating portion 3a and the strip light-guiding portion 3b is not limited to that described in the above embodiment. For example, the shape of the strip light-guiding portion 3b may be in the shape of a right triangle with the illuminating portion 3a as the base. Then, the strip light-guiding portion 3b having such a shape may be formed into an annular shape so as to be secured to the inner surface of the control knob 1. In other words, any light guiding unit can be used as long as it has a strip light-guiding portion that annularly extends from an illuminating portion exposed at the pointer display element, along the inner surface of the control knob.

Likewise, the configuration of the planar light-emitting unit 4 is not limited to that described in the above embodiment. The planar light-emitting unit can be configured in any manner which allows light from the light source to be incident on the lower surface of the strip light-guiding portion annularly extending along the inner surface of the control knob.

What is claimed is:

1. An illumination-type rotational control device comprising:
a rotatable control knob having a tubular member with a top plate and a pointer display element;
a light guiding unit integral with the control knob;
a planar light-emitting unit configured to direct light on the light guiding unit,
wherein the light guiding unit has an illuminating portion disposed in the pointer display element and a strip light-guiding portion annularly extending along an inner surface of the control knob; and
the light guiding unit configured to allow light emerging from the planar light-emitting unit to be incident on a lower surface of the strip light-guiding portion, and to guide the light to the illuminating portion.

2. The illumination-type rotational control device according to claim 1, wherein the strip light-guiding portion tapers such that a length of the strip light-guiding portion in a direction parallel to a rotational axis of the control knob decreases with distance from the illuminating portion.

3. The illumination-type rotational control device according to claim 2, wherein both the upper and lower surfaces of the strip light-guiding portion are inclined with respect to respective planes orthogonal to the rotational axis of the control knob.

4. The illumination-type rotational control device according to claim 1, wherein the planar light-emitting unit has an annular light exiting surface which allows light emitted from a light source to emerge obliquely toward the lower surface of the strip light-guiding portion.
